(19) United States
(12) Patent Application Publication
(10) Pub. No.: US 2013/0308199 A1
(43) Pub. Date: Nov. 21, 2013

(54) BI-TELECENTRIC CONTINUOUS ZOOM IMAGING DEVICE

(71) Applicants: SHIN-GWO SHIUE, HSINCHU CITY (TW); JIM CHUNG, HSINCHU CITY (TW); HSIEN-HUNG MENG, HSINCHU CITY (TW)

(72) Inventors: SHIN-GWO SHIUE, HSINCHU CITY (TW); JIM CHUNG, HSINCHU CITY (TW); HSIEN-HUNG MENG, HSINCHU CITY (TW)

(73) Assignee: HSINTEK OPTICAL INSTRUMENT CO., HSINCHU CITY (TW)

(21) Appl. No.: 13/474,886

(22) Filed: May 18, 2012

(51) Int. Cl. G02B 13/22

(52) U.S. Cl. 359/663

(57) ABSTRACT

A bi-telecentric continuous zoom imaging device, comprising: a collimation object lens set, to convert parallel light beams of interference patterns into a convergent light beam, and to guide it onto an imaging route through optical route adjusting means. A telecentric imaging module converts interference pattern on imaging route into a telecentric image paralleling to an optical axis. Then, a bi-telecentric continuous zoom module adjusts a magnification ratio of telecentric image, and then outputs an object image. Finally, object image is formed on a charge coupled device (CCD). Through application of bi-telecentric continuous zoom imaging device, deficiency of conventional measurement system can be improved, even if the object distance is changed the magnification ratio of image can be kept, minimum optical distortion and good resolution can also be maintained.

### BACKGROUND OF THE INVENTION

1. Field of the Invention

The present invention relates to a bi-telecentric continuous zoom imaging device, and in particular to a bi-telecentric continuous zoom imaging device, that is capable of minimizing optical distortion through bi-telecentric imaging, to raise the measuring precision for object at large distance.

2. The Prior Arts

Along with the progress and development of precision measurement technology, the precise measurement of minute elements can be realized through optical means. Due to its advantages of high accuracy and non-destruction, it has been used widely in various sectors of the Industries. In this respect, an interferometric system capable of measuring optical elements or other physical quantities by means of optical interference is taken as example for explanation. Presently, there are various kinds of interferometric systems, yet their principles of design are quite similar. By way of example, the Fizau interferometer utilized widely in the Industries is taken as an example. The interference fringes imaging system utilizes the light beam reflected from two planes, to interfere with each other to produce interference patterns. Then, a set of collimation object lenses reflect the interference patterns to a zoom lens, and that performs the adjustments required based on the distance to the object-to-be-measured. Finally, the interference patterns are transmitted to a camera for it to read the interference fringes. However, in this way, the quality of the interference fringes depends on the imaging system, so that when the distance to the object is changed, the magnification ratio, distortion, and resolution of the imaging system are changed, thus affecting its accuracy of measurement.

Moreover, in a conventional interferometer imaging system, image of interference fringes is formed on a rotational diffuser, and this image is treated as an object image on a zoom lens, and that is formed on the focal plane of the zoom lens for a camera. The purpose of this design is to solve the problem of noise generated in the optical route of an interferometer. Yet the addition of a rotational diffuser also creates the following problems, such as image noise is increased since the interference fringes are not imaged directly on a CCD, the transmission rate of the rotation diffuser, and the lowering of its Modulation Transformation Function (MTF). In addition, since image is formed on a Labertian surface of the rotation diffuser, so that when image is formed on a CCD through the following zoom lens, a Vignetting phenomenon is likely to occur. This could produce fairly large difference of illumination between edges and center of an interference image, hereby causing difficulty in recognizing the image. In order to redress this deficiency, a fairly high caliber zoom lens is required, thus resulting in an increase of cost and rendering it not quite applicable.

Therefore, presently, the design and performance of interference fringe imaging system are not quite satisfactory, and it has much room for improvements.

### SUMMARY OF THE INVENTION

In view of the problems and drawbacks of the prior art, the present invention provides a bi-telecentric continuous zoom imaging device, so as to overcome the shortcomings of the prior art.

A major objective of the present invention is to provide a bi-telecentric continuous zoom imaging device. Wherein, double-section bi-telecentric lenses are used to make the Chief Ray parallel to the optical axis on both object side and the image side, so that the maximum field of view and image on the imaging side are fairly fixed, hereby solving the problem that the magnification ratio of an ordinary lens can be affected by the distance to the object-to-be-measured.

Another objective of the present invention is to provide a bi-telecentric continuous zoom imaging device. Wherein, a double-section telecentric lens imaging approach is adopted to provide wide field depth, thus making it advantageous for measuring non-planar objects, while keeping resolution of the interference fringes, without being affected by the various surface depths of the object-to-be-measured, in achieving high quality imaging.

A further objective of the present invention is to provide a single magnification system by removing the continuous zoom module, and also as a double-section bi-telecentric optical imaging system, wherein modular design is used to increase the flexibility of applying the system.

A yet another objective of the present invention is to provide a bi-telecentric continuous zoom imaging device, that can be used widely in an interferometer instrument, in a related measurement instrument making use of the interferometric principle, in a related interference fringe imaging device, and in an ordinary imaging instrument for a continuous zoom imaging device.

In order to achieve the above-mentioned objectives, the present invention provides a bi-telecentric continuous zoom imaging device, comprising: a collimation object lens set, a telecentric imaging module, a bi-telecentric continuous zoom module; and a Charge Coupled Device (CCD). Wherein, a light projector is used to project a light beam, such as a laser light beam into a collimation object lens set, that is reflected and modulated into parallel light beams of interference pattern, then it is converted into a convergent light beam, and it is guided onto an imaging route. The telecentric imaging module is used to convert the interference patterns on the imaging route into a telecentric image, to solve the problem of the prior art that image of interference fringes is adversely affected by the depth of field and depth of focus of the object-to-be-measured. In this way, a bi-telecentric continuous zoom module is used to adjust the magnification ratio of the telecentric imaging, and then it outputs an object image. Finally, an object image is formed directly on a Charge Coupled Device, and is converted into electronic signals.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a bi-telecentric continuous zoom imaging device according to the present invention;

FIG. 2 is a schematic diagram illustrating adjusting magnification ratio of an object image according to the present invention; and

FIG. 3 is a schematic diagram illustrating applying the bi-telecentric continuous zoom imaging device into an interferometer according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

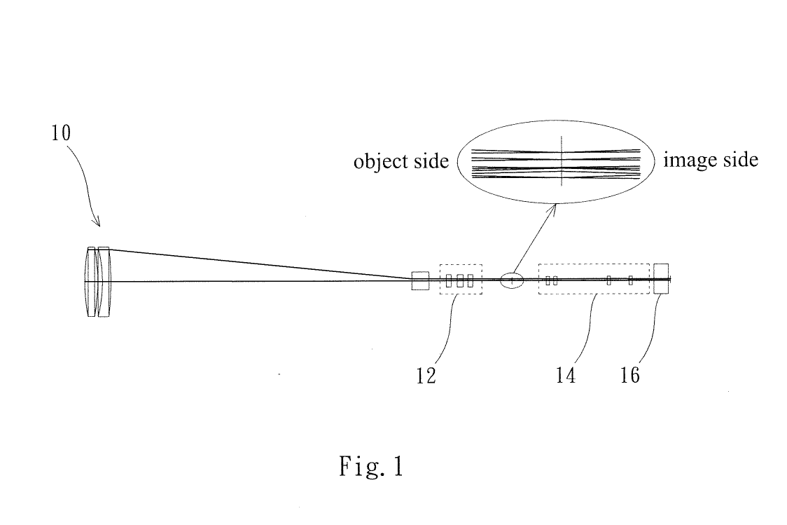

Refer to FIG. 1 for a schematic diagram of a bi-telecentric continuous zoom imaging device according to the present invention. As shown in FIG. 1, the bi-telecentric continuous zoom imaging device of the present invention includes: a collimation object lens set 10, a telecentric imaging module 12, a telecentric continuous zoom module 14; and a Charge Coupled Device (CCD) 16. Wherein, the collimation object lens set 10 is used to receive the parallel light beams of the interference patterns of an object-to-be-measured, and convert them into a convergent light beam, then guide it onto an imaging route. The telecentric imaging module 12 is used to convert the interference patterns on the imaging route into a telecentric image parallel to the optical axis. The telecentric imaging module is used mainly to adjust the interference patterns into a telecentric image of constant magnification ratio. Namely, in the present invention, collimation object lens set and 10 and telecentric imaging module 12 can be combined together to serve solely as fix magnification ratio system, so that the magnification ratio of the interference fringe image can be kept constant, without being affected by the distance to the object-to-be-measured. The position of telecentric imaging is as shown in the enlarged portion of FIG. 1. Wherein, the telecentric imaging module 12 is preferably formed by three sets of relay lenses.

Of course, the bi-telecentric continuous zoom module 14 can be used in cooperation with the telecentric imaging module 12, as a double-section telecentric optical imaging system, to correct the optical distortion of the prior art. To be more specific, in case of small object measurement, which need to enlarge object so that the bi-telecentric continuous zoom module 14 can be used to adjust the magnification ratio of the telecentric imaging, and output an object image. Finally an object image is formed directly on a Charge Coupled Device 16, and that is converted into electronic signals.

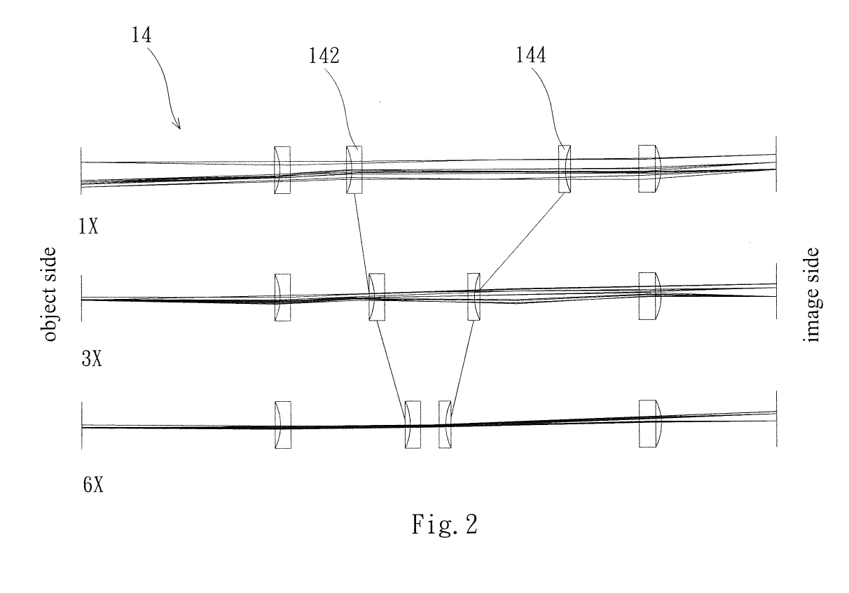

In the descriptions mentioned above, in order to describe the way of bi-telecentric continuous zooming, also refer to FIG. 2 for a schematic diagram illustrating adjusting magnification ratio of an object image according to the present invention. As shown in FIG. 2, the telecentric continuous zoom module 14 can be zoomed between a factor of 1 and 6, to adjust the magnification ratio of the interference light on the imaging route, and output an object image. By way of example, the bi-telecentric continuous zoom module 14 may include 4 zoom lenses, wherein, two zoom lenses 142 and 144 are required to be adjusted, such that through adjusting spacing between the two zoom lenses 142 and 144, the object image can be enlarged or reduced. As viewed from the object side and image side in the drawing, the closer the spacing between the two zoom lenses 142 and 144, the larger the magnification ratio of the object image. Since the bi-telecentric continuous zoom module 14 is placed directly in the focal plane of the Charge Coupled Device 16, so that an object image can be formed directly on Charge Coupled Device 16, and then it is converted into electronic signals.

From the descriptions mentioned above, it can be known that, the double-telecentric continuous zoom imaging device can be used widely in an interferometer instrument, in a related measurement instrument making use of the interferometric principle, in a related interference fringe imaging device, and in an ordinary imaging instrument for a continuous zoom imaging device.

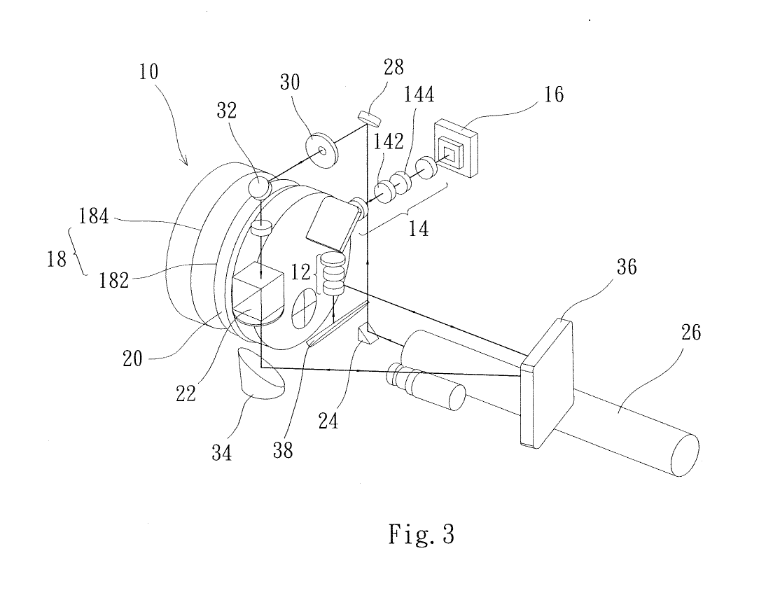

In order to describe further the applications of the present invention, herein, the interferometer instrument is taken as an example for explanation. Meanwhile, refer to FIGS. 1 and 3 at the same time. FIG. 3 is a schematic diagram illustrating applying the bi-telecentric continuous zoom imaging device into an interferometer according to the present invention. In general, an interferometer can be divided into two sections. One section is a light projector for projecting lights, and the other section is an interference fringe imaging device. The purpose of the present invention is to make improvement to the imaging device. In other words, through the application of the innovative optical structure of the present invention, the image magnification ratio can be kept constant, without being affected by the variations of distance to the object-to-be-measured, as such reducing the optical distortion significantly. In order to understand thoroughly the operation of the present invention, the structure and operation of an interferometer are described in details as follows.

As shown in FIG. 3, the collimation object lens set 10 includes: two planes 18, including object and reference planes, a collimation device 20, and a polarizing beam splitter (PBS) set 22. Firstly, the interferometer of the present invention further includes: a light projector, a plurality of reflection mirrors and a reflection block 24 disposed on an optical route between the light projector and the polarizing beam splitter set 22. The light projector can be a laser device 26, for projecting helium-neon laser light beam. The laser light beam is filtered and magnified by a built-in filter (not shown), then it is reflected in sequence through a reflection block 24, and a corresponding reflection mirror 28 having an inclination angle, to an attenuator 30. The attenuator 30 is disposed on the optical route of the light projector, mainly to reduce the amplitude of the laser light beam, while not distorting its phase and frequency, in achieving light modulation.

Upon being modulated through the attenuator 30, the laser light beam is reflected by a reflection mirror 32 having an inclination angle to a polarizing beam splitter 22 having a ¼ wave plate to transmit through it. Then, the transmitted polarization light is reflected in sequence through a rod mirror 34 and a primary mirror 36 to change its direction, such that it is reflected into a collimation device 20. In general, the collimation device 20 is made of collimation lenses, so that the laser light beam enters between two planes 18. Wherein, the two planes include a reference plane 182 and test plane 184.

Subsequently, the bi-telecentric optical imaging is described. When the laser light beam enters between the two planes 18, the reflected light beams from the reference plane 182 and the reflected light beams from the test plane 184 interfere with each other to produce an interference pattern of the object-to-be measured. Then the collimation device 20 converts the parallel light beams of the interference patterns into convergent light beams of interference fringes. Then, the adjusting means on the optical route formed by the primary mirror 36 and the rod mirror 34 guides the interference fringes from the collimation device 20 to the polarizing beam splitter 22, and that will reflect the interference fringes of laser light beam, and guides it onto an imaging route. On the optical route between the polarizing beam splitter 22 and the telecentric imaging module 12 is further provided with a planar reflection mirror 38, which guides the convergent light of the interference fringes to the telecentric imaging module 12. Through the telecentric imaging module 12, the interference pattern on the imaging route is converted into a telecentric image parallel to the optical axis. In this approach, the telecentric imaging module 12 is used to adjust the interference pattern into a telecentric image of constant magnification ratio, so as to keep the magnification ratio of the interference fringe image unchanged, without being affected by the distance to the object-to-be-measured.

Then, the bi-telecentric continuous zoom module 14 is used to work in cooperation with the telecentric imaging module 12, so that in case the object-to-be-measured is changed so its size is changed, or a smaller area is to be measured, the bi-telecentric continuous zoom module 14 can be used to adjust the magnification ratio of the telecentric image, and to output an object image. Finally, an object image is formed directly onto a Charge Coupled Device, and that is converted into electronic signals. In this way, the present invention is indeed capable of improving the optical characteristics of telecentric imaging, with its optical adjustment means divides the telecentric imaging into two sections. Wherein, the collimation object lens set and the telecentric imaging module are the front section focusing and imagining system, so that the chief ray entering the imaging side is made to parallel to the optical axis. The bi-telecentric continuous zoom module forms the rear section continuous zoom imaging system, so the chief ray on the object side is parallel to the optical axis. In the design mentioned above, the telecentric imaging module 12 and the telecentric continuous zoom module 14 can be connected directly in series, to form a bi-telecentric interferometer continuous zoom imaging device. Of course, in addition to being used in the interferometer, the bi-telecentric continuous zoom imaging device is considered in the scope of the present invention, as long as it is used in a bi-telecentric imaging way to improve the optical characteristics of any continuous zoom imaging device.

Summing up the above, the design of the present invention has the following advantages:
(1) The magnification ratio of the interference fringe image can be kept constant, without being affected by the change of the distance to the object-to-be-measured.
(2) The design of bi-telecentric imaging is used to achieve better optical resolution, to allow object distance to change over 4 meters, and magnification ratio of continuous zoom imaging can be a factor between 1 and 6, thus achieving minimum optical distortion regardless of object distance change or continuous zooming, to improve the deficiency of the prior art that the optical distortion becoming serious when the object distance is large.
(3) It can be applied to thicker and deeper object-to-be-measured, so that the measuring condition can be more flexible.
(4) When the distance to object-to-be-measured is changed to require adjusting focus, the magnification ratio of the system can be kept constant. Meanwhile, the illumination of the interference fringe image can be maintained, so that the imaging range is fixed in achieving better quality of images.
(5) Modular design is used to raise application flexibility and its competitiveness on the market.

Due to the various advantages mentioned above, through application of the present invention, the precision of optical measurement can be raised significantly, thus it has a good competitive edge on the market.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A bi-telecentric continuous zoom imaging device, comprising:
a collimation object lens set, to convert parallel light beam of interference patterns into a convergent light beam, and to guide it onto an imaging route;
a telecentric imaging module, to convert said interference patterns on said imaging route into a telecentric image;
a bi-telecentric continuous zoom module, to adjust magnification ratio of said telecentric image, and output an object image; and
a Charge Coupled Device (CCD), on which said object image is formed, to convert it into electronic signals.

2. The bi-telecentric continuous zoom imaging device as claimed in claim 1 wherein said collimation object lens set includes: two planes, a collimation device, and a polarizing beam splitter (PBS) set, such that reflected light beams from said two planes interfere with each other, to produce an interference pattern of an object-to-be-measured, so that parallel light beams of said interference pattern is converted by said collimation device into a convergent light beam, and then that is guided by said polarizing beam splitter (PBS) set onto said imaging route.

3. The bi-telecentric continuous zoom imaging device as claimed in claim 2, wherein said interference pattern produced by said two planes is formed by reflection light beam of a test plane and reflection light beam of a reference plane interfering with each other.

4. The bi-telecentric continuous zoom imaging device as claimed in claim 2, wherein reflection light beam of said two planes is provided by a light projector of an interferometer.

5. The bi-telecentric continuous zoom imaging device as claimed in claim 4, further comprising: an attenuator is disposed on optical route of said light projector.

6. The bi-telecentric continuous zoom imaging device as claimed in claim 4, wherein a plurality of reflection mirrors and a reflection block are disposed on said optical route between said light projector and said polarizing beam splitter (PBS) set.

7. The bi-telecentric continuous zoom imaging device as claimed in claim 1, wherein on said optical route between said telecentric imaging module and said bi-telecentric continuous zoom module is further provided with at least a reflection mirror, to reflect said telecentric image parallel to said optical axis to said telecentric continuous zoom module.

8. The bi-telecentric continuous zoom imaging device as claimed in claim 1, wherein said telecentric imaging module adjusts said interference patterns into said telecentric image of constant magnification ratio.

9. The bi-telecentric continuous zoom imaging device as claimed in claim 1, wherein said bi-telecentric continuous zoom module adjusts distance between at least two zoom lenses, with a magnification ratio of continuous zoom between a factor of 1 and 6.

10. The bi-telecentric continuous zoom imaging device as claimed in claim 1, wherein said telecentric imaging module is made of a relay lens set.
